(19) United States
(12) Patent Application Publication
(10) Pub. No.: US 2004/0112495 A1
(43) Pub. Date: Jun. 17, 2004

(54) Self inflating tire

(75) Inventor: Curtis Arlen Weise, Hendersonville, TN (US)

Correspondence Address: Curtis Arlen Weise, 115 Woodvale Drive, Hendersonville, TN, 37075, US

(73) Assignee: Curtis Arlen Weise, Hendersonville, TN

(21) Appl. No.: 10/729,890

(22) Filed: Dec. 8, 2003

Related U.S. Application Data
(60) Provisional application No. 60/431,669, filed on Dec. 9, 2002.

(51) Int. Cl. B60C 5/00

(52) U.S. Cl. 152/331.1

(57) ABSTRACT

This invention modifies the conventional pneumatic tire and allows the tire to inflate itself to the desired running pressure by driving the vehicle it is mounted on. It consists of a bladder (or diaphragm) or preferably two or more bladders (or diaphragms), mounted to the inside surface of the tire, with check valves and a air supply tube which is connected to the atmosphere by way of a small hole in the sidewall of the tire. The invention employs an inflation valve (new invention) which allows for over pressure relief and a the ability to set the desired tire inflation pressure. The air inflation valve allows for quick inflations and eliminates the necessity for inflating checking pressure and adjusting and checking several times.

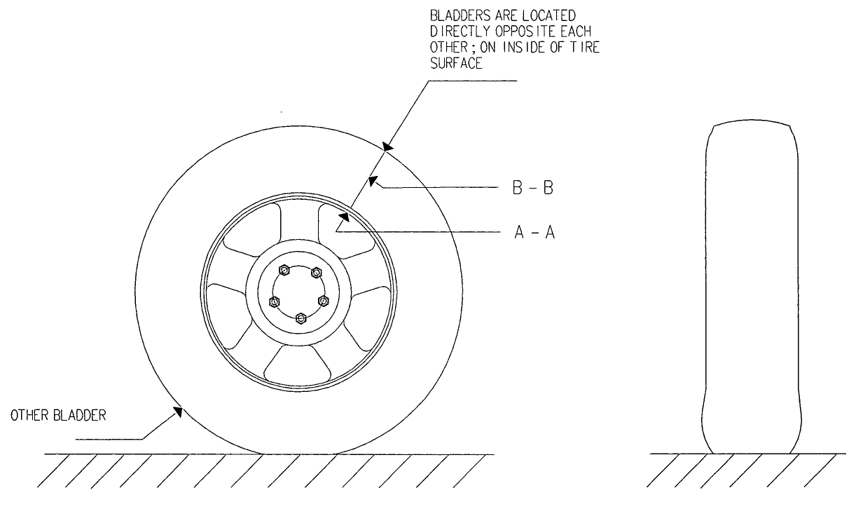

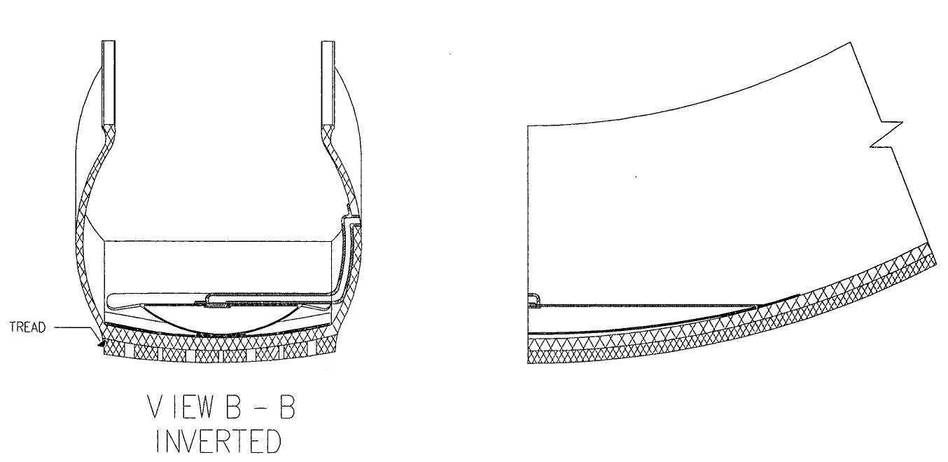

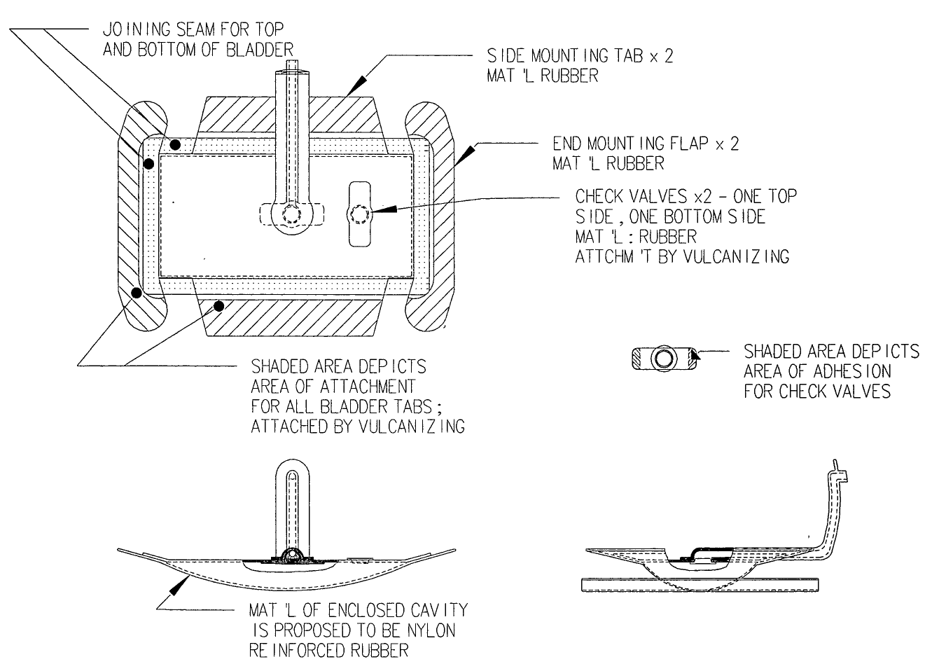

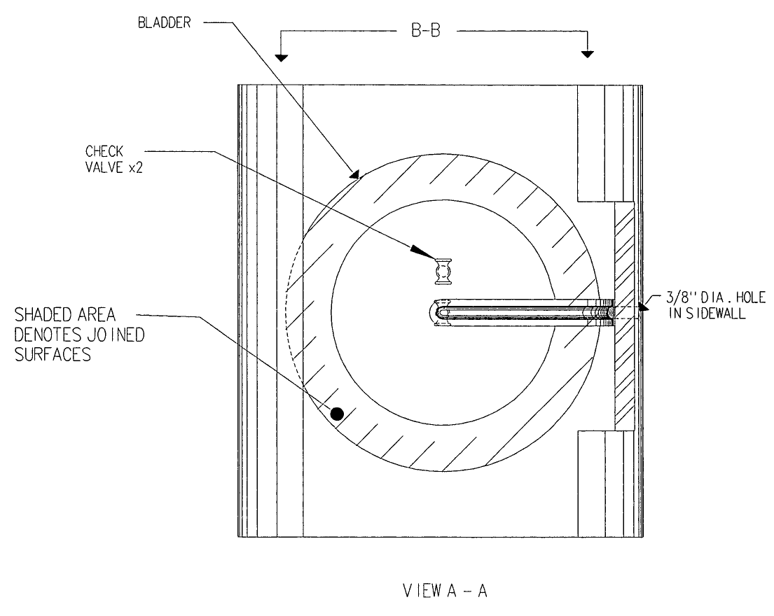

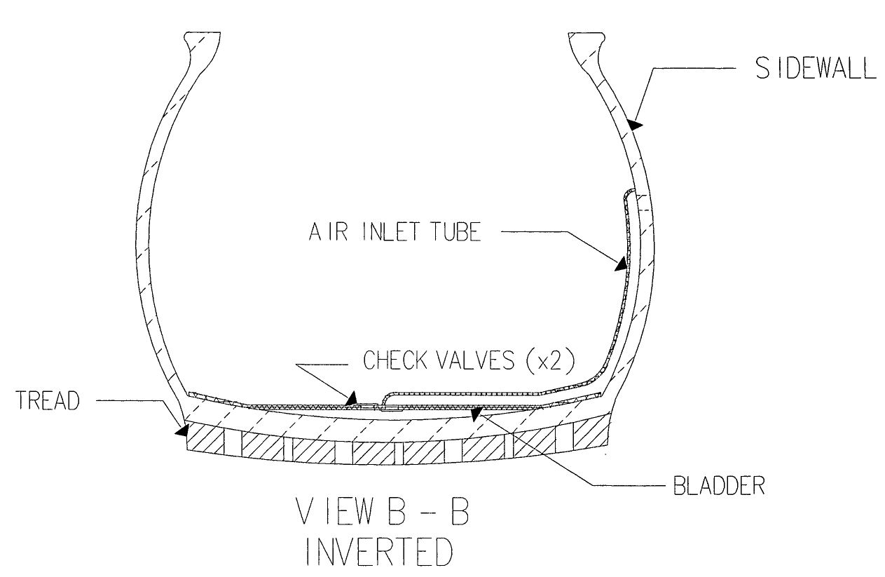

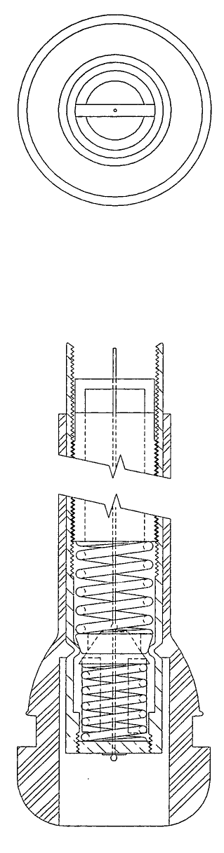

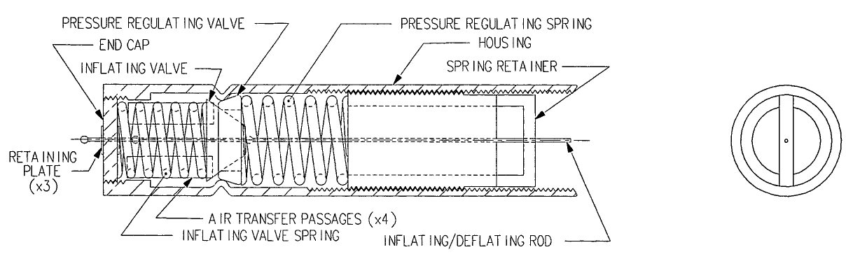

Two designs of the self inflating tire are provided. One design employs a bladder or bladders and the other employs a diaphragm or diaphragms.

The preferred design of the self-inflating tire consists of a bladder (or bladders) inside the tire which is connected through an air passage opening(s) to the outside air. It (they) is (are) attached to the inside of the tire, and on the surface opposite the tread. This design is depicted by drawings numbered SIT001, SIT002 (two sheets), SITV01 (two sheets) and accompanying two page description (specification) for SITV01.

The bladder has a one-way check valve that allows air to enter the bladder during the air intake phase and halts air passage during the tire inflation stage. It has another one way check valve that opens to allow air to pass from the bladder enclosed space and into the tire during the inflation phase but closes to prevent leakage from the tire during the air intake phase. I am proposing two bladders in each tire to help with tire balance. Two will also provide redundancy should one of the bladders become punctured.

The design includes a Pressure Regulating; High Flow Tire Inflation Valve that allows for a means of setting the desired tire pressure and a pressure relief function, for those periods when inflation is at desired levels, to prevent over inflating the tire.

The bladder design is the preferred over the diaphragm design (described later), because there will be no impact on tread wear or passenger feel since the pressure on all inside surfaces of the tire will be the same as the internal pressure of the tire (this will not be true with the diaphragm design). Air from the tire will be under the bladder, allowed to pass between the end and side mounting tabs of the bladder. I am proposing that the length of the bladder, not including the end mounting tabs, be equal to the length of the contact patch of a properly inflated tire and the lowest point of the bladder's cavity (but not the mounting tabs) be one-sixteenth inch above the inside surface of the tire as the tire comes off the manufacturing line (not mounted on a vehicle). I am proposing that the width of the bladder (not including mounting tabs) be approximately three inches. The depth of the bladder cavity is proposed to be approximately equal to the vertical deflection of the tire internal surface when mounted with recommended inflation pressure.

The bladder itself should be of two piece construction with the top one piece and the bottom, sides and mounting tabs another piece. The pieces to be vulcanized together when using reinforced rubber as the bladder material. The tabs will have an area free of being joined to the tire allowing for stretching without harming the closed chamber of the bladder or the bond of the tabs to the tire.

### HOW IT WORKS

Even on the lightest of automobiles, the force exerted on the tire, in contact with the road surface, is enough to cause the tire to flatten and provide a “contact patch”. An examination of the contact patch of the tire reveals that the most tire deflection occurs at the center of the tread (because of the rounding of the internal surface, opposite the tread, from side to side of tire design) and directly in line with the wheel's vertical center line. The logical conclusion that can be drawn from this fact is that the forces directed on the center of the tire and in line with the vertical centerline of the wheel are greater than for any other portion of the contact patch. This design places the bladder(s) in the center of the tire, opposite the tread, and takes advantage of the radial deflection and subsequent re-rounding as the tire rolls.

When the tread under the bladder is in contact with the road, the weight of the vehicle causes the tread to flatten and compress the air trapped inside the bladder which, in turn, pushes air from the bladder, through a check valve, into the tire. When that same tread area rotates off the road surface that area of the tire assumes the round shape again, caused by the “memory” in the rubber and substrate. The action of re-rounding exerts force on the side mounting tabs of the bladder which, in turn, pulls open the bladder cavity thereby creating a low pressure inside the bladder. This action closes the check valve into the tire and opens the check valve to the outside air allowing the bladder to take another small gulp of air. The self inflation is more prevalent at low speeds and less at high speeds because the air traveling around the tire at higher speeds is eddy and/or air foil low pressure.

### ADVANTAGES

Most tire leaks are small and often go unnoticed until the tire becomes perceptively flattened and then only when the vehicle operator pays attention to the tires. The self inflating tire will be safer by preventing tires from the over-heating tread damage related to under inflation and preventing the under inflated tire from bead separation during swift cornering. The tire tread will last longer because of having the proper inflation nearly 100% of the run time regardless of the temperature of the tire. An additional benefit will be the convenience factor. The operator of the vehicle will not have to inflate his/her tires as often, if ever, even if he/she gets a puncture typical of most punctures. If a puncture through one of the bladders is experienced, the second bladder will supply the inflation.

The Pressure Regulating; High Flow Tire Inflation Valve is depicted in a drawing numbered SITV01 and operationally described in a two page description (specification).

The Pressure Regulating; High Flow Tire Inflation Valve, once the desired pressure is set (the valve relief pressure is variable and can be set to the desired tire pressure), allows the owner to inflate the tire without having to relieve the pressure when he over inflates by a couple of pounds. The valve will allow a slow release of air till the set pressure is obtained. With today's typical “valve core”, the over inflation must be relieved by depressing the needle of the valve and then checking again to be sure one has relieved enough pressure, but not too much. The design of my inflation valve allows much faster inflation/deflation because of the much larger areas for air transfer vs. the current commonly used valve. Should the tire owner need to add pressure to his tire, he will be able to do so more quickly than he could with today's “valve core” design.

### BLADDER MATERIAL SELECTION

There are numerous materials that could be used as the bladder material provided that the material can be reliably attached to the inside of the tire. I have chosen fiberglass or nylon reinforced rubber for the bladder cavity and rubber only for the mounting tabs in this rendering because they are compounds tire manufactures are familiar with and should have no trouble reliably joining to the tire. The rubber only tabs have a joining free area right adjacent to the cavity of the bladder which will allow the more flexible rubber portion of the bladder to follow the tire flexing and limit stressing on the joint and the reinforced bladder cavity.

### ALTERNATE (DIAPHRAGM) SELECTION

An alternative design is also provided using a diaphragm(s). This design is depicted on drawing numbered SIT003 (two pages).

The diaphragm(s) connect(s) to the atmosphere and employs check valves just as the bladder design does. It also utilizes the Pressure Regulating; High Flow Tire Valve described earlier. With the diaphragm design, however, there is a cavity between the diaphragm and the inside surface of the tire. As the tire rotates the cavity expands and contracts in a similar manner as does the bladder design. However there may be a perceptible feel by the passenger and a possible wear pattern on the tread. These drawbacks may be overcome by making the diaphragms small or by compensating for the lower pressure under the diaphragms by strengthening the tire design in the area of the diaphragms. This diaphragm design may also be located on the tire sidewall similar to that described for the bladder design. This location will not result in passenger feel or strange tread wear pattern.

The diaphragm material is proposed to be nylon or fiberglass reinforced rubber except for the joining periphery and a joining free area. The purpose of the joining-free-rubber-only area is to allow for flexing of the diaphragm with the tire without providing unnecessary stress on the joined area.

What I claim as my invention is:

I. The use of a diaphragm or diaphragms attached to the inside tire surface and connected to the atmosphere through a hole or holes in the tire and incorporating valves in the diaphragm(s) to allow air to transfer from the atmosphere into the diaphragm(s)/tire enclosed compartment and pressurized air to be transferred from that compartment into the main inflation chamber of the tire as the tire rotates off and on the tread surface area under the diaphragm(s). This claim is for diaphragm(s) whether they are mounted on the radial surface or the sidewall surface and whether they connect to the atmosphere with or without a breathing tube.

II. The use a bladder or bladders attached to the inside tire surface and connected to the atmosphere through a hole in the tire and incorporating valves to allow air to transfer from the atmosphere into the bladder(s) and pressurized air to be transferred from the bladder(s) into the main inflation chamber of the tire as the tire rotates off and on the tread surface. The claim is for bladder(s) whether they are mounted on the radial surface or the sidewall of the tire and whether it(they) connect to the atmosphere with or without a breathing tube.

III. A pressure relieving inflation valve which utilizes two springs, two moveable valves which move together to provide pressure relief from the tire and move relative to each other to allow inflation from an external source along with a threaded adjustment to permit setting the force on one of the springs which, in turn, allows the desired inflation pressure (over pressure relief) for the tire to be set.
